(19) United States
(12) Patent Application Publication
(10) Pub. No.: US 2022/0121004 A1
(43) Pub. Date: Apr. 21, 2022

(54) IMAGING LENS AND IMAGING APPARATUS

(71) Applicant: FUJIFILM Corporation, Tokyo (JP)

(72) Inventors: Taiga NODA, Saitama (JP); Yoshiaki ISHII, Saitama (JP); Hiroki SAITO, Saitama (JP)

(73) Assignee: FUJIFILM Corporation, Tokyo (JP)

(21) Appl. No.: 17/562,915

(22) Filed: Dec. 27, 2021

Related U.S. Application Data
(63) Continuation of application No. PCT/JP2020/022748, filed on Jun. 9, 2020.

(30) Foreign Application Priority Data
Jun. 27, 2019 (JP) 2019-119981
Dec. 26, 2019 (JP) 2019-237435

(51) Int. Cl. G02B 9/64; G02B 13/00

(52) U.S. Cl. CPC G02B 9/64; G02B 13/006

(57) ABSTRACT

The imaging lens includes, as lens groups in order from the object side, only a first lens group, a second lens group, and a third lens group. During focusing, the second lens group moves, and the first lens group and the third lens group remain stationary. The first lens group includes at least two groups of cemented lenses. Assuming that a focal length of a lens closest to the object side is f1, a focal length of the imaging lens in a state where an infinite distance object is in focus is f, and an air conversion distance on the optical axis from a lens surface closest to the image side to a focal position on the image side of the imaging lens in a state where an infinite distance object is in focus is Bf, the imaging lens satisfies Conditional Expressions (1): 0.1<f1/f<1 and (2): Bf/f<0.14.

### CROSS-REFERENCE TO RELATED APPLICATIONS

This application is a continuation application of International Application No. PCT/JP2020/022748, filed on Jun. 9, 2020, which is incorporated herein by reference in its entirety. Further, this application claims priority from Japanese Patent Application No. 2019-119981, filed on Jun. 27, 2019, and Japanese Patent Application No. 2019-237435, filed on Dec. 26, 2019. Each application above is hereby expressly incorporated by reference, in its entirety, into the present application.

### BACKGROUND

### Technical Field

The present disclosure relates to an imaging lens and an imaging apparatus.

### Related Art

In the related art, various imaging lenses applicable to imaging apparatuses such as digital cameras have been proposed. For example, JP6387630B discloses an optical system having a focus lens and a first lens group disposed adjacent to the object side of the focus lens. The first lens group has, in order from the object side, a positive lens, a cemented lens, and a positive lens. Further, JP6387631B discloses an optical system consisting of substantially two lens groups including a first lens group disposed adjacent to the object side of the focus lens and having a positive refractive power and a second lens group disposed on the image side of the first lens group, including a focus lens, and having a negative refractive power.

### SUMMARY

An object of the present disclosure is to provide an imaging lens, which maintains favorable optical performance and achieves reduction in size, and an imaging apparatus comprising the imaging lens.

According to a first aspect of the present disclosure, there is provided an imaging lens comprising, as lens groups, only three lens groups consisting of, in order from an object side to an image side: a first lens group that remains stationary with respect to an image plane during focusing; a second lens group that moves along an optical axis during focusing; and a third lens group that remains stationary with respect to the image plane during focusing. The first lens group includes at least two cemented lenses in which at least one positive lens and at least one negative lens are cemented. Assuming that a focal length of a lens closest to the object side in the first lens group is f1, a focal length of the whole system in a state where an infinite distance object is in focus is f, and an air conversion distance on the optical axis from a lens surface closest to the image side to a focal position on the image side of the whole system in a state where an infinite distance object is in focus is Bf, Conditional Expressions (1) and (2) are satisfied.

0.1<f1/f<1 (1)

Bf/f<0.14 (2)

According to a second aspect of the present disclosure, there is provided an imaging lens comprising, as lens groups, successively in order from a position closest to an object side to an image side: a first lens group that remains stationary with respect to an image plane during focusing; a second lens group that moves along an optical axis during focusing; and a subsequent lens group that is at a distance which is changeable in a direction of the optical axis from the second lens group during focusing. The first lens group has at least two cemented lenses in which at least one positive lens and at least one negative lens are cemented, the subsequent lens group has at least two cemented lenses in which at least one positive lens and at least one negative lens are cemented, and assuming that a focal length of a lens closest to the object side in the first lens group is f1, a focal length of the whole system in a state where an infinite distance object is in focus is f, and an air conversion distance on the optical axis from a lens surface closest to the image side to a focal position on the image side of the whole system in a state where an infinite distance object is in focus is Bf, Conditional Expressions (1) and (2) are satisfied.

0.1<f1/f<1 (1)

Bf/f<0.14 (2)

According to a third aspect of the present disclosure, in the imaging lens according to the second aspect, the subsequent lens group consists of a third lens group that remains stationary with respect to the image plane during focusing.

It is preferable that the imaging lens according to the above-mentioned aspect satisfies Conditional Expression (1-1).

0.2<f1/f<0.8 (1-1)

In the imaging lens according to the above-mentioned aspect of the present disclosure, assuming that a focal length of the cemented lens closest to the object side in the first lens group is fC1 and the focal length of the whole system in the state where the infinite distance object is in focus is f, it is preferable to satisfy Conditional Expression (3).

0<fC1/f<150 (3)

In the imaging lens according to the above-mentioned aspect, assuming that a focal length of a single lens or the cemented lens adjacent to the image side of the cemented lens closest to the object side in the first lens group is fs and the focal length of the whole system in the state where the infinite distance object is in focus is f, it is preferable to satisfy Conditional Expression (4).

0<fs/f<2.5 (4)

In the imaging lens according to the above-mentioned aspect, assuming that a focal length of the cemented lens of the first lens group, which is different from the cemented lens closest to the object side in the first lens group, is fC2, it is preferable to provide at least one cemented lens satisfying Conditional Expression (5).

−30<fC2/f<30 (5)

In the imaging lenses of the first and third aspects, it is preferable that the third lens group has at least one cemented lens. Assuming that a focal length of a cemented lens closest to the object side in the third lens group is fC3 and the focal length of the whole system in the state where the infinite distance object is in focus is f, it is preferable to satisfy Conditional Expression (6).

−8<fC3/f<8 (6)

In the imaging lenses of the first and third aspects, it is preferable that a stop is disposed between a lens surface closest to the image side in the first lens group and a lens surface closest to the object side in the third lens group, and the third lens group has at least one cemented lens. Assuming that a combined focal length of three lenses disposed successively adjacent to the image side of a cemented lens closest to the object side in the third lens group is fC4 and the focal length of the whole system in the state where the infinite distance object is in focus is f, it is preferable to satisfy Conditional Expression (7).

−1<fC4/f<0 (7)

In the imaging lens according to the above-mentioned aspect, it is preferable to provide at least one cemented lens closer to the image side than the second lens group. Assuming that a focal length of a cemented lens closest to the image side is fC5 and the focal length of the whole system in the state where the infinite distance object is in focus is f, it is preferable to satisfy Conditional Expression (8).

0.05<fC5/f<1 (8)

In the imaging lens according to the above-mentioned aspect, assuming that a focal length of a single lens or a cemented lens closest to the image side is fe and the focal length of the whole system in the state where the infinite distance object is in focus is f, it is preferable to satisfy Conditional Expression (9).

0<fe/f<0.4 (9)

In the imaging lens according to the above-mentioned aspect, it is preferable that a diffractive optical surface is provided. In such a configuration, it is preferable that the diffractive optical surface is disposed in the first lens group.

In the imaging lens according to the above-mentioned aspect, it is preferable to provide a lens that has an Abbe number greater than 100 based on a d line. The lens having an Abbe number greater than 100 based on the d line may be a positive lens. It is preferable that the first lens group includes the lens having an Abbe number greater than 100 based on the d line, and more specifically, it is preferable that the cemented lens closest to the object side in the first lens group includes the lens.

In the imaging lens according to the above-mentioned aspect, it is preferable that a cemented lens in which a positive lens and a negative lens are cemented is disposed closest to the image side.

In the imaging lens according to the above-mentioned aspect, it is preferable to provide at least four cemented lenses closer to the image side than the second lens group.

An imaging apparatus according to another aspect of the present disclosure comprises the imaging lens according to the above aspect of the present disclosure.

In the present specification, it should be noted that the terms “consisting of ˜” and “consists of ˜” mean that the lens may include not only the above-mentioned components but also lenses substantially having no refractive powers, optical elements, which are not lenses, such as a stop, a filter, and a cover glass, and mechanism parts such as a lens flange, a lens barrel, an imaging element, and a camera shaking correction mechanism.

It should be noted that the term “the whole system” of the present specification means an imaging lens. Further, the term “˜ group having a positive refractive power” means that the group has a positive refractive power as a whole. Similarly, the term “˜ group having a negative refractive power” means that the group has a negative refractive power as a whole. The term “a lens having a positive refractive power” and the term “a positive lens” are synonymous. The term “a lens having a negative refractive power” and the term “negative lens” are synonymous. The term “˜ lens group” is not limited to a configuration consisting of a plurality of lenses, but may consist of only one lens. The term “single lens” means one uncemented lens. One lens component means one single lens or one cemented lens.

A compound aspheric lens (that is, a lens in which a spherical lens and an aspheric film formed on the spherical lens are integrally formed and function as one aspheric lens as a whole) is not regarded as cemented lenses, but the compound aspheric lens is regarded as one lens. Unless otherwise specified, the sign of refractive power, the surface shape, and the curvature radius of a lens including an aspheric surface are considered in terms of the paraxial region.

The “focal length” used in a conditional expression is a paraxial focal length. The values used in Conditional Expressions are values in a case where the d line is used as a reference. The “d line”, “C line”, “F line”, and “g line” described in the present specification are emission lines. The wavelength of the d line is 587.56 nm (nanometers) and the wavelength of the C line is 656.27 nm (nanometers), the wavelength of F line is 486.13 nm (nanometers), and the wavelength of g line is 435.84 nm (nanometers).

According to the present disclosure, it is possible to provide an imaging lens, which maintains favorable optical performance and achieves reduction in size, and an imaging apparatus comprising the imaging lens.

### BRIEF DESCRIPTION OF THE DRAWINGS

FIG. 1 is a cross-sectional view corresponding to the imaging lens of Example 1 of the present disclosure and showing a configuration and luminous flux of an imaging lens according to an embodiment of the present disclosure.

FIG. 2 is a cross-sectional view showing a configuration of an imaging lens according to Example 2 of the present disclosure.

FIG. 3 is a cross-sectional view showing a configuration of an imaging lens according to Example 3 of the present disclosure.

FIG. 4 is a cross-sectional view showing a configuration of an imaging lens according to Example 4 of the present disclosure.

FIG. 5 is a cross-sectional view showing a configuration of an imaging lens according to Example 5 of the present disclosure.

FIG. 6 is a diagram showing aberrations of the imaging lens of Example 1 of the present disclosure.

FIG. 7 is a diagram showing aberrations of the imaging lens of Example 2 of the present disclosure.

FIG. 8 is a diagram showing aberrations of the imaging lens of Example 3 of the present disclosure.

FIG. 9 is a diagram showing aberrations of the imaging lens of Example 4 of the present disclosure.

FIG. 10 is a diagram showing aberrations of the imaging lens of Example 5 of the present disclosure.

FIG. 11 is a perspective view of the front side of an imaging apparatus according to an embodiment of the present disclosure.

FIG. 12 is a perspective view of the rear side of the imaging apparatus according to the embodiment of the present disclosure.

### DESCRIPTION OF EMBODIMENTS

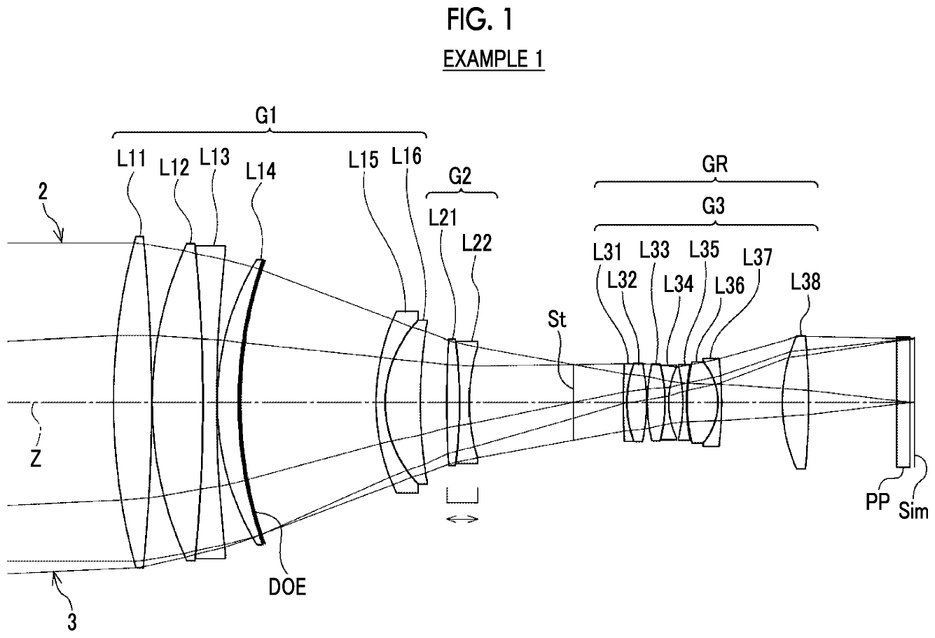

Hereinafter, embodiments of the present disclosure will be described in detail with reference to the accompanying drawings. FIG. 1 shows a configuration of a cross section including an optical axis Z of an imaging lens according to an embodiment of the present disclosure. The example shown in FIG. 1 corresponds to the imaging lens of Example 1 to be described later. In FIG. 1, the left side is the object side, the right side is the image side, and a state where the infinite distance object is in focus is shown. FIG. 1 also shows on-axis luminous flux 2 and luminous flux with the maximum angle of view 3 as the luminous flux.

FIG. 1 shows an example in which, assuming that an imaging lens is applied to an imaging apparatus, an optical member PP having a parallel plate shape is disposed on the image side of the imaging lens. The optical member PP is a member assumed to include various filters, a cover glass, and/or the like. The various filters include, for example, a low pass filter, an infrared cut filter, and a filter that cuts a specific wavelength region. The optical member PP has no refractive power, and the optical member PP may be configured to be omitted.

The imaging lens of the present disclosure comprises, as lens groups successively in order from the position closest to the object side to the image side, a first lens group G1, a second lens group G2, and a subsequent lens group GR. During focusing from the infinite distance object to the shortest range object, the first lens group G1 remains stationary with respect to the image plane Sim, the second lens group G2 moves along the optical axis Z, and thereby the distance between the second lens group G2 and the subsequent lens group GR in the direction of the optical axis changes. The parentheses and double-headed arrows below the second lens group G2 shown in FIG. 1 mean that the second lens group G2 is a lens group (hereinafter referred to as a focus group) that moves during focusing.

FIG. 1 shows, as an example, an example in which the subsequent lens group GR consists of the third lens group G3. The imaging lens of the example of FIG. 1 consists of, as lens groups in order from the object side to the image side, three lens groups including a first lens group G1, a second lens group G2, and a third lens group G3. The third lens group G3 in the example of FIG. 1 remains stationary with respect to the image plane Sim during focusing from the infinite distance object to the shortest range object. By adopting a configuration in which the subsequent lens group GR remains stationary with respect to the image plane Sim during focusing, it is possible to suppress fluctuations in the balance of the lens weight due to focusing.

The inner focus type lens system as described above is able to prevent the intrusion of dust since the total length of the lens does not change during focusing. Further, the inner focus type lens system has an advantage in favorable usability and excellent convenience at the time of imaging since the total optical length does not change during focusing. The total length of the lens described herein is the length on the optical axis from the lens surface closest to the object side to the lens surface closest to the image side, and the total optical length is a length on the optical axis from the lens surface closest to the object side to the image plane Sim.

By setting the focus group in only the second lens group G2, it is possible to reduce the size and weight of the focus group as compared with a lens system in which the focus group consists of a plurality of lens groups. As a result, the load on the drive system for driving the focus group can be reduced, and there is an advantage in achieving reduction in size of the imaging apparatus and also in an increase in speed of focusing.

For example, in the imaging lens shown in FIG. 1, the first lens group G1 consists of six lenses L11 to L16 in order from the object side to the image side, the second lens group G2 consists of two lenses L21 and L22 in order from the object side to the image side, and the third lens group G3 consists of eight lenses L31 to L38 in order from the object side to the image side. Here, the number of lenses constituting each lens group may be different from that in the example shown in FIG. 1.

The first lens group G1 includes at least two cemented lenses in which at least one positive lens and at least one negative lens are cemented. By arranging two cemented lenses near the object side of the entire lens system, it is possible to suppress occurrence of longitudinal chromatic aberration and lateral chromatic aberration. Therefore, it is possible to reduce the load of chromatic aberration correction on the image side of the entire lens system. In the example shown in FIG. 1, the first lens group G1 has two cemented lenses, the lens L12 and the lens L13 are cemented to each other, the lens L15 and the lens L16 are cemented to each other, and the other lenses in first lens group G1 are uncemented single lenses.

The second lens group G2 may be configured to consist of two lenses. In such a case, there is an advantage in achieving reduction in size and weight of the focus group. At that time, the two lenses of the second lens group G2 may be cemented to each other. In such a case, there is an advantage in achieving reduction in size and weight of the focus group. Further, the second lens group G2 may be configured to consist of one positive lens and one negative lens. In such a case, there is an advantage in suppressing fluctuation in chromatic aberration during focusing.

It is preferable that the third lens group G3, which is the subsequent lens group GR, has at least one cemented lens. More specifically, it is preferable that the third lens group G3 has at least one cemented lens in which at least one positive lens and at least one negative lens are cemented. In a case where the third lens group G3, which is the lens closest to the image side group, has the above-mentioned cemented lens, it is possible to perform chromatic aberration correction while maintaining a balance with the cemented lens of the first lens group G1.

It is more preferable that the third lens group G3, which is the subsequent lens group GR, has at least two cemented lenses in which at least one positive lens and at least one negative lens are cemented. In such a case, there is an advantage in suppressing occurrence of chromatic aberration due to focusing, and there is also an advantage in eliminating insufficiency in correction of chromatic aberration in the first lens group G1.

In the example shown in FIG. 1, the third lens group G3 has three cemented lenses, the lens L31 and the lens L32 are cemented to each other, the lens L33 and the lens L34 are cemented to each other, the lens L36 and the lens L37 are cemented to each other, and the other lenses in the third lens group G3 are uncemented single lenses.

In the example of FIG. 1, the single lens is disposed closest to the image side in the whole system, but the cemented lens in which the positive lens and the negative lens are cemented may be configured to be disposed closest to the image side in the whole system. In a case where the cemented lens in which the positive lens and the negative lens are cemented is disposed closest to the image side in the whole system, there is an advantage in correcting lateral chromatic aberration.

Further, unlike the example of FIG. 1, a configuration may be made such that at least four cemented lenses closer to the image side than the second lens group G2 are provided. In such a case, it is possible to correct longitudinal chromatic aberration that cannot be completely removed by the first lens group G1 and to correct lateral chromatic aberration.

In the example shown in FIG. 1, the first lens group G1 has a positive refractive power as a whole, the second lens group G2 has a negative refractive power as a whole, and the third lens group G3 has a negative refractive power as a whole. In a case where the imaging lens adopts the telephoto type configuration as described above, there is an advantage in shortening the total optical length.

It is preferable that the aperture stop St is disposed between the lens surface closest to the image side in the first lens group G1 and the lens surface closest to the object side in the third lens group G3. By disposing the aperture stop St in this range, the lens diameter of the second lens group G2 can be reduced, and the weight of the focus group can be reduced. As an example, in the imaging lens shown in FIG. 1, an aperture stop St is disposed between the second lens group G2 and the third lens group G3. It should be noted that the aperture stop St shown in FIG. 1 does not indicate a shape thereof but indicates a position thereof on the optical axis.

Next, a configuration relating to conditional expressions will be described. In the imaging lens of the present disclosure, assuming that a focal length of the lens closest to the object side in the first lens group G1 is f1 and a focal length of the imaging lens in a state where the infinite distance object is in focus is f, Conditional Expression (1) is satisfied. By not allowing the corresponding value of Conditional Expression (1) to be equal to or less than the lower limit, there is an advantage in suppressing occurrence of spherical aberration. By not allowing the corresponding value of Conditional Expression (1) to be equal to or greater than the upper limit, there is an advantage in achieving reduction in diameter of the lens closer to the image side than the lens closest to the object side in the first lens group G1. Further, in a case of the configuration satisfying Conditional Expression (1-1), more favorable characteristics can be obtained. In a case of the configuration satisfying Conditional Expression (1-2), more favorable characteristics can be obtained.

0.1<f1/f<1 (1)

0.2<f1/f<0.8 (1-1)

0.4<f1/f<0.75 (1-2)

Further, in the imaging lens of the present disclosure, assuming that an air conversion distance on the optical axis from the lens surface closest to the image side to a focal position on the image side of the whole system in the state where the infinite distance object is in focus by Bf and the focal length of the whole system in a state where the infinite distance object is in focus is f, Conditional Expression (2) is satisfied. Bf is a back focal length. By not allowing the corresponding value of Conditional Expression (2) to be equal to or greater than the upper limit, the back focal length can be shortened with respect to the focal length. Therefore, it is easy to achieve reduction in size in the direction of the optical axis, and this configuration is suitable for a small imaging apparatus such as a short mirrorless camera of which the flange back is short. A mirrorless camera is a camera in which a mirror for guiding light to a finder by deflecting the optical path is not disposed between the lens system and the imaging element on which a subject image is formed. It is preferable that the imaging lens according to the present disclosure further satisfies Conditional Expression (2-1). By not allowing the corresponding value of Conditional Expression (2-1) to be equal to or less than the lower limit, the lens system and the imaging element do not come excessively close to each other. As result, it is easy to ensure an appropriate space around the imaging element. Further, in a case of a configuration in which Conditional Expression (2-2) is satisfied, it is possible to obtain more favorable characteristics.

Bf/f<0.14 (2)

0.02<Bf/f<0.13 (2-1)

0.05<Bf/f<0.12 (2-2)

By satisfying Conditional Expressions (1) and (2), the imaging lens of the present disclosure can be miniaturized in the radial direction and the direction of the optical axis while suppressing occurrence of spherical aberration. There is an advantage in realizing a lens system having favorable optical performance while achieving reduction in size.

Further, in the imaging lens according to the present disclosure, assuming that a focal length of the cemented lens closest to the object side in the first lens group G1 is fC1 and the focal length of the whole system in the state where the infinite distance object is in focus is f, it is preferable to satisfy Conditional Expression (3). Hereinafter, for convenience of explanation, the cemented lens closest to the object side in the first lens group G1 will be referred to as the cemented lens closest to the object side. By not allowing the corresponding value of Conditional Expression (3) to be equal to or less than the lower limit, there is an advantage in suppressing occurrence of spherical aberration. By not allowing the corresponding value of Conditional Expression (3) to be equal to or greater than the upper limit, there is an advantage in reducing the diameter of the lens closer to the image side than the cemented lens closest to the object side. Further, in a case of the configuration satisfying Conditional Expression (3-1), more favorable characteristics can be obtained. In a case of the configuration satisfying Conditional Expression (3-2), more favorable characteristics can be obtained.

0<fC1/f<150 (3)

0.5<fC1/f<100 (3-1)

1.1<fC1/f<50 (3-2)

In the imaging lens of the present disclosure, assuming that a focal length of a single lens or a cemented lens adjacent to the image side of the cemented lens closest to the object side is fs and a focal length of the whole system in a state where the infinite distance object is in focus is f, it is preferable to satisfy Conditional Expression (4). fs is a focal length of the lens component adjacent to the image side of the cemented lens closest to the object side. In the example shown in FIG. 1, the focal length of the lens L14 corresponds to fs. By not allowing the corresponding value of Conditional Expression (4) to be equal to or less than the lower limit, there is an advantage in suppressing occurrence of spherical aberration. By not allowing the corresponding value of Conditional Expression (4) to be equal to or greater than the upper limit, there is an advantage in reducing the diameter of the lens closer to the image side than the lens component adjacent to the image side of the cemented lens closest to the object side. Further, in a case of the configuration satisfying Conditional Expression (4-1), more favorable characteristics can be obtained. In a case of the configuration satisfying Conditional Expression (4-2), more favorable characteristics can be obtained.

0<fs/f<2.5 (4)

0.2<fs/f<2 (4-1)

0.4<fs/f<1.2 (4-2)

In the imaging lens of the present disclosure, assuming that a focal length of the cemented lens of the first lens group G1 different from the cemented lens closest to the object side is fC2 and the focal length of the whole system in the state where the infinite distance object is in focus is f, it is preferable that at least one cemented lens satisfying Conditional Expression (5) is provided. In the example shown in FIG. 1, the focal length of the cemented lens consisting of the lens L15 and the lens L16 corresponds to fC2. By satisfying Conditional Expression (5), it is possible to perform aberration correction through the cemented lens relating to Conditional Expression (5) and aberration correction through the lenses on the object side and the image side of the cemented lens in a well-balanced manner. Further, it is more preferable that the imaging lens of the present disclosure has at least one cemented lens satisfying Conditional Expression (5-1). By making the refractive power of the cemented lens relating to Conditional Expression (5-1) negative and not allowing the corresponding value of Conditional Expression (5-1) to be equal to or less than the lower limit, it is possible to make the cemented lens relating to Conditional Expression (5-1) have an appropriate negative refractive power. Thereby, the cemented lens gives a divergent action to the ray that has been converged by the lens closer to the object side than the cemented lens and emits the ray such that the ray approaches the direction parallel to the optical axis Z, and the ray can be incident on the second lens group G2 which is a focus group. Therefore, it is possible to suppress fluctuation in aberrations during focusing. By not allowing the corresponding value of Conditional Expression (5-1) to be equal to or greater than the upper limit, there is an advantage in suppressing occurrence of spherical aberration. Further, the imaging lens of the present disclosure is able to obtain more favorable characteristics in a case where the imaging lens is configured to have at least one cemented lens satisfying Conditional Expression (5-2).

−30<fC2/f<30 (5)

−12<fC2/f<0 (5-1)

−8<fC2/f<0 (5-2)

In the configuration in which the third lens group G3 has at least one cemented lens, assuming that a focal length of the cemented lens closest to the object side in the third lens group G3 is fC3 and the focal length of the whole system in the state where the infinite distance object is in focus is f, it is preferable that the imaging lens of the present disclosure satisfies Conditional Expression (6). By satisfying Conditional Expression (6), it is possible to perform aberration correction through the cemented lens closest to the object side in the third lens group G3 and aberration correction through the lenses on the object side and the image side of the cemented lens in a well-balanced manner. Further, it is preferable that Conditional Expression (6-1) is satisfied. By not allowing the corresponding value of Conditional Expression (6-1) to be equal to or less than the lower limit, there is an advantage in suppressing occurrence of spherical aberration. By not allowing the corresponding value of Conditional Expression (6-1) to be equal to or greater than the upper limit, it is possible to perform aberration correction through the cemented lens closest to the object side in the third lens group G3 and aberration correction through the lenses on the object side and the image side of this cemented lens in a more balanced manner. Furthermore, in a case of a configuration in which Conditional Expression (6-2) is satisfied, it is possible to obtain more favorable characteristics.

−8<fC3/f<8 (6)

0.1<fC3/f<5 (6-1)

0.15<fC3/f<1 (6-2)

A stop is disposed between the lens surface closest to the image side in the first lens group G1 and the lens surface closest to the object side in the third lens group G3 and the third lens group G3 has at least one cemented lens. In such a configuration, assuming that a combined focal length of three lenses disposed successively adjacent to the image side of the cemented lens closest to the object side in the third lens group G3 is fC4 and the focal length of the whole system in a state where the infinite distance object is in focus is f, it is preferable that the imaging lens of the present disclosure satisfies Conditional Expression (7). Here, assuming that each lens is a component, the number of lenses is counted. Accordingly, regarding the cemented lens, assuming that each individual lens constituting the cemented lens is one, the number of lenses is counted. However, this does not apply to diffractive optical surfaces. In the example shown in FIG. 1, the combined focal length of the lens L33, the lens L34, and the lens L35 corresponds to fC4. It is possible to ensure an appropriate negative refractive power by making the combined refractive power of the three lenses relating to Conditional Expression (7) negative and not allowing the corresponding value of Conditional Expression (7) to be equal to or less than the lower limit. There is an advantage in obtaining high telecentricity by bouncing off-axis light luminous flux, and there is also an advantage in enhancing the correction effect of off-axis aberration in the lens closer to the image side by separating the on-axis luminous flux 2 and the off-axis luminous flux. By not allowing the corresponding value of Conditional Expression (7) to be equal to or greater than the upper limit, there is an advantage in suppressing occurrence of astigmatism. Further, in a case of the configuration satisfying Conditional Expression (7-1), more favorable characteristics can be obtained. In a case of the configuration satisfying Conditional Expression (7-2), more favorable characteristics can be obtained.

−1<fC4/f<0 (7)

−0.2<fC4/f<0 (7-1)

−0.08<fC4/f<0 (7-2)

In the configuration in which the imaging lens has at least one cemented lens closer to the image side than the second lens group G2, assuming that a focal length of the cemented lens closest to the image side in the whole system is fC5 and the focal length of the whole system in a state where the infinite distance object is in focus is f, it is preferable that the imaging lens of the present disclosure satisfies Conditional Expression (8). By not allowing the corresponding value of Conditional Expression (8) to be equal to or less than the lower limit, there is an advantage in suppressing occurrence of spherical aberration and astigmatism. By not allowing the corresponding value of Conditional Expression (8) to be equal to or greater than the upper limit, it is possible to perform aberration correction through the cemented lens closest to the image side in the whole system and aberration correction through the lenses on the object side and the image side of the cemented lens in a well-balanced manner. Further, in a case of the configuration satisfying Conditional Expression (8-1), more favorable characteristics can be obtained. In a case of the configuration satisfying Conditional Expression (8-2), more favorable characteristics can be obtained.

0.05<fC5/f<1 (8)

0.07<fC5/f<0.6 (8-1)

0.1<fC5/f<0.4 (8-2)

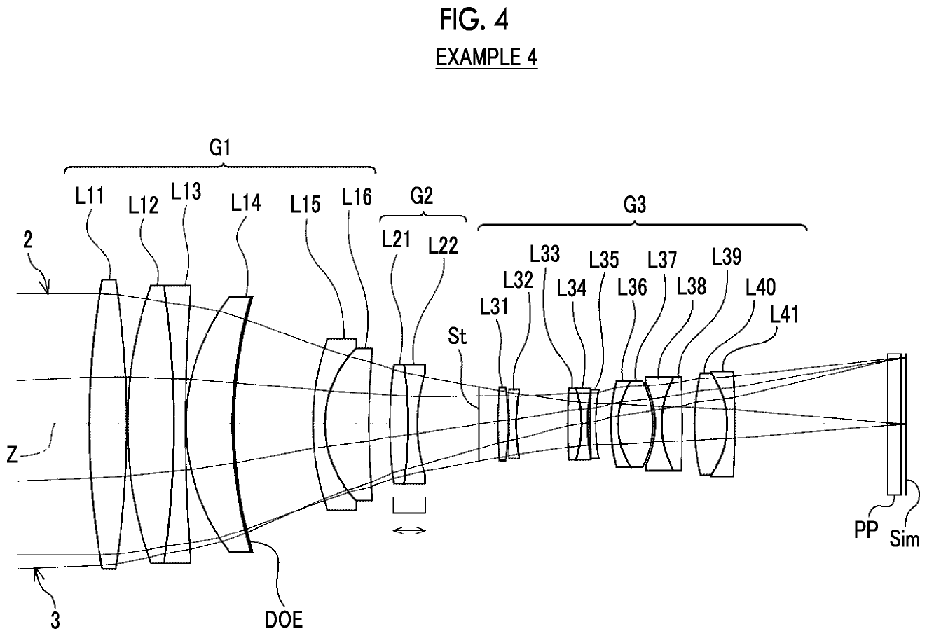

Assuming that a focal length of a single lens or a cemented lens closest to the image side in the whole system is fe and the focal length of the whole system in the state where the infinite distance object is in focus is f, it is preferable that the imaging lens of the present disclosure satisfies Conditional Expression (9). fe is the focal length of the lens component closest to the image side in the whole system. In the example shown in FIG. 1, the focal length of the lens L38 corresponds to fe. In the example shown in FIG. 4 to be described later, the focal length of the cemented lens in which the lens L40 and the lens L41 are cemented corresponds to fe. By satisfying Conditional Expression (9), it is easy to ensure high telecentricity. Further, in a case of the configuration satisfying Conditional Expression (9-1), more favorable characteristics can be obtained. In a case of the configuration satisfying Conditional Expression (9-2), more favorable characteristics can be obtained.

0<fe/f<0.4 (9)

0<fe/f<0.35 (9-1)

0.1<fe/f<0.22 (9-2)

The imaging lens of the present disclosure may be configured such that a diffractive optical surface diffractive optical element (DOE) is disposed. The diffractive optical surface DOE is a surface on which a fine lattice structure is formed, and the diffractive optical surface DOE is able to control light by utilizing the diffraction phenomenon of light. The diffractive optical element, which is an optical element on which the diffractive optical surface DOE is disposed, has a dispersion characteristic opposite to that of a normal refraction type lens. Therefore, by making the effect of correcting chromatic aberration large and partially changing the lattice pitch, an aspheric lens-like action can be easily obtained. By adopting a configuration including the diffractive optical surface DOE, there is an advantage in suppressing chromatic aberration and reducing the weight of the lens system.

It is preferable that the diffractive optical surface DOE is disposed in the first lens group G1. In general, the first lens group G1, which is the lens group closest to the object side, tends to have a large lens diameter, and therefore the weight thereof also tends to be heavy. By disposing the diffractive optical surface DOE which is advantageous for aberration correction in the first lens group G1, it is possible to reduce the number of lenses in the first lens group G1 as compared with the case where the diffractive optical surface DOE is not disposed. As a result, it is possible to obtain a great effect on the reduction in weight of the lens system. In the example shown in FIG. 1, the diffractive optical surface DOE is disposed on the image side surface of the lens L14.

Further, it is preferable that the imaging lens of the present disclosure has a lens having an Abbe number greater than 100 based on the d line. In such a case, there is an advantage in correcting chromatic aberration. In a case where a lens having an Abbe number greater than 100 based on the d line is a positive lens, there is an advantage in suppressing occurrence of longitudinal chromatic aberration by using a low-dispersion lens as the positive lens.

It is preferable that the first lens group G1 includes the lens having an Abbe number greater than 100 based on the d line. In such a case, there is an advantage in suppressing chromatic aberration, particularly longitudinal chromatic aberration. In the example shown in FIG. 1, the lens having an Abbe number greater than 100 based on the d line is the lens L12. In a case where the cemented lens closest to the object side in the first lens group G1 includes the lens having an Abbe number greater than 100 based on the d line, there is an advantage in suppressing chromatic aberration, particularly longitudinal chromatic aberration.

The above-mentioned preferred configurations and available configurations including the configurations relating to Conditional Expressions may be any combination, and it is preferable to appropriately selectively adopt the configurations in accordance with required specification. For example, according to the first aspect and the second aspect described below, it is possible to realize an imaging lens that maintains favorable optical performance and is miniaturized.

The imaging lenses according to the first aspect comprises, as lens groups, only three lens groups consisting of, in order from the object side to the image side: a first lens group G1 that remains stationary with respect to the image plane Sim during focusing; a second lens group G2 that moves along the optical axis Z during focusing; and a third lens group G3 that remains stationary with respect to the image plane Sim during focusing. The first lens group G1 has at least two cemented lenses in which at least one positive lens and at least one negative lens are cemented, and satisfies Conditional Expressions (1) and (2).

The imaging lens according to the second aspect comprises, as lens groups successively in order from the position closest to the object side to the image side: a first lens group G1 that remains stationary with respect to the image plane Sim during focusing; a second lens group G2 that moves along the optical axis Z during focusing; and a subsequent lens group GR that is at a distance which is changeable in a direction of the optical axis from the second lens group G2 during focusing. The first lens group G1 has at least two cemented lenses in which at least one positive lens and at least one negative lens are cemented, the subsequent lens group GR has at least two cemented lenses in which at least one positive lens and at least one negative lens are cemented. With such a configuration, Conditional Expressions (1) and (2) are satisfied.

Next, examples of the imaging lens of the present disclosure will be described. The reference numerals attached to the lenses in the cross-sectional views of each example are used independently for each example in order to avoid complication of description due to an increase in the number of digits of the reference numerals. Therefore, even in a case where common reference numerals are attached in the drawings of different examples, components do not necessarily have a common configuration.

### EXAMPLE 1

FIG. 1 is a cross-sectional view showing a configuration and luminous flux of an imaging lens of Example 1, and an illustration method thereof is as described above. Therefore, description is partially not repeated herein. The imaging lens of Example 1 consists of, in order from the object side to the image side, a first lens group G1 having a positive refractive power, a second lens group G2 having a negative refractive power, an aperture stop St, and a third lens group G3 having a negative refractive power. During focusing from the infinite distance object to the closest object, the first lens group G1, the aperture stop St, and the third lens group G3 remain stationary with respect to the image plane Sim, and the second lens group G2 moves along the optical axis Z. The first lens group G1 consists of, in order from the object side to the image side, a lens L11 which is a positive lens, lenses L12 and L13 which constitute a cemented lens, a lens L14 which is a positive lens, and lenses L15 and L16 which constitute a cemented lens. The second lens group G2 consists of lenses L21 and L22 which constitute a cemented lens. The third lens group G3 consists of, in order from the object side to the image side, lenses L31 and L32 which constitute a cemented lens, lenses L33 and L34 which constitute a cemented lens, a lens L35 which is a negative lens, lenses L36 and L37 which constitute a cemented lens, and a lens L38 which is a positive lens. The diffractive optical surface DOE is disposed on the image side surface of the lens L14. The outline of the imaging lens of Example 1 has been described above.

Regarding the imaging lens of Example 1, Table 1 shows basic lens data, Table 2 shows specification, and Table 3 shows phase difference coefficients thereof. In Table 1, the column of Sn shows surface numbers. The surface closest to the object side is the first surface, and the surface numbers increase one by one toward the image side. The column of R shows curvature radii of the respective surfaces. The column of D shows surface distances on the optical axis between the respective surfaces and the surfaces adjacent to the image side. Further, the column of Nd shows refractive indices of the respective components at the d line, and the column of νd shows Abbe numbers of the respective components based on the d line.

In Table 1, the sign of the curvature radius of the surface convex toward the object side is positive and the sign of the curvature radius of the surface convex toward the image side is negative. Table 1 also shows the aperture stop St and the optical member PP. In Table 1, in a place of a surface number of a surface corresponding to the aperture stop St, the surface number and a term of (St) are noted. A value at the bottom place of D in Table 1 indicates a distance between the image plane Sim and the surface closest to the image side in the table.

Table 2 shows values of the focal length f, the F number FNo, and the maximum total angle of view 2ω of the imaging lens, based on the d line. (°) in the place of 2ω indicates that the unit thereof is a degree. The values shown in Table 2 are values in the case of using the d line as a reference in a state where the infinite distance object is in focus.

In Table 1, the surface number and the phrase (DOE) are noted in the column of the surface number of the surface corresponding to the diffractive optical surface DOE. In Table 3, the Sn column shows the surface number of the diffractive optical surface DOE, and the Ak (k is an even number of 2 or more) column shows the numerical value of the phase difference coefficient of the diffractive optical surface DOE. The “E−n” (n: an integer) in numerical values of the phase difference coefficients of Table 3 indicates “×10⁻ⁿ”. The shape of the diffractive optical surface DOE is determined by the phase difference function Φ(h) described below. Ak is a phase difference coefficient in the phase difference function Φ(h) expressed by the following expression. h in the following expression is a height from the optical axis. Σ in the following expression means a sum of k.

Φ(h)=ΣAk×h^{k}

In data of each table, a degree is used as a unit of an angle, and mm (millimeter) is used as a unit of a length, but appropriate different units may be used since the optical system can be used even in a case where the system is enlarged or reduced in proportion. Each of the following tables shows numerical values rounded off to predetermined decimal places.

TABLE 1

| Sn | R | D | Nd | vd |
|---|---|---|---|---|
| 1 | 141.84604 | 8.356 | 1.48749 | 70.44 |
| 2 | −378.93630 | 0.150 | | |
| 3 | 86.23024 | 11.147 | 1.41390 | 100.82 |
| 4 | −358.76706 | 3.010 | 1.56732 | 42.82 |
| 5 | 294.64539 | 0.150 | | |
| 6 | 62.71836 | 4.840 | 1.51633 | 64.14 |
| 7 | 97.17999 | 0.004 | 1.53458 | 18.90 |
| 8(DOE) | 97.17999 | 0.090 | 1.59952 | 45.78 |
| 9 | 97.17999 | 30.000 | | |
| 10 | 48.13472 | 2.000 | 1.88300 | 40.76 |
| 11 | 26.56889 | 7.724 | 1.48749 | 70.24 |
| 12 | 107.23202 | 5.821 | | |
| 13 | 236.39990 | 2.834 | 1.63980 | 34.47 |
| 14 | −107.45817 | 2.003 | 1.72916 | 54.68 |
| 15 | 44.12223 | 22.839 | | |
| 16(St) | ∞ | 11.014 | | |
| 17 | 163.50380 | 0.800 | 1.92286 | 18.90 |
| 18 | 25.56104 | 4.334 | 1.64769 | 33.79 |
| 19 | −41.90013 | 0.150 | | |
| 20 | 37.26060 | 3.883 | 1.64769 | 33.79 |
| 21 | −34.74822 | 0.800 | 1.72916 | 54.68 |
| 22 | 18.99840 | 3.123 | | |
| 23 | −34.89723 | 0.800 | 1.72916 | 54.68 |
| 24 | 44.83227 | 0.150 | | |
| 25 | 38.80631 | 6.792 | 1.63980 | 34.47 |
| 26 | −14.27101 | 0.800 | 1.74100 | 52.64 |
| 27 | −81.67799 | 13.350 | | |
| 28 | 36.66529 | 5.799 | 1.51823 | 58.90 |
| 29 | −150.45703 | 19.378 | | |
| 30 | ∞ | 2.850 | 1.51680 | 64.20 |
| 31 | ∞ | 1.036 | | |

TABLE 2

| | |
|---|---|
| f | 292.94 |
| FNo. | 4.11 |
| 2ω(°) | 5.6 |

TABLE 3

| Sn | 8 |
|---|---|
| A2 | −5.32157E−01 |
| A4 | −2.66627E−05 |

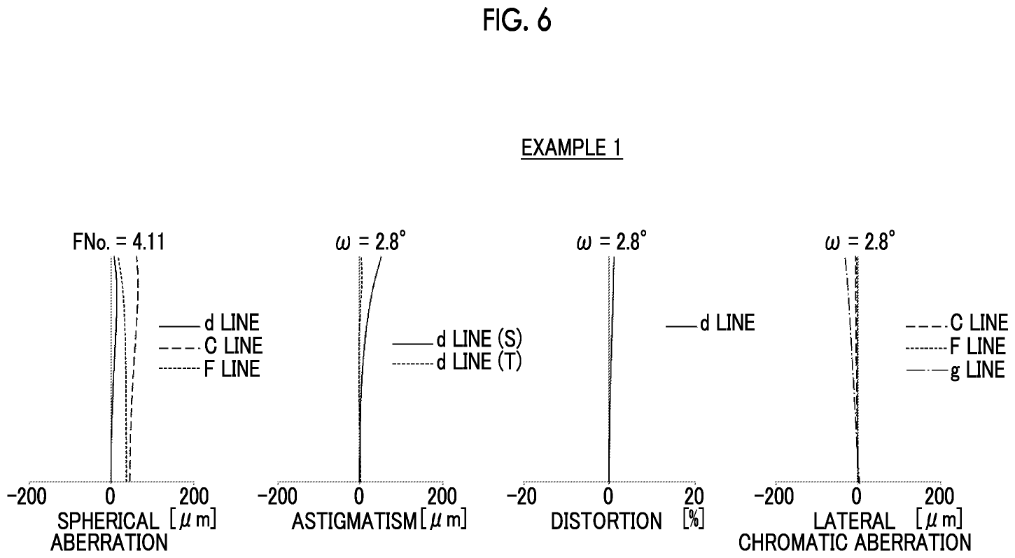

FIG. 6 shows a diagram showing aberrations of the imaging lens of Example 1. In FIG. 6, in order from the left side, spherical aberration, astigmatism, distortion, and lateral chromatic aberration are shown. In spherical aberration diagram, aberrations at the d line, the C line, and the F line are indicated by the solid line, the long broken line, and the short broken line, respectively. In the astigmatism diagram, aberration in the sagittal direction at the d line is indicated by the solid line, and aberration in the tangential direction at the d line is indicated by the short broken line. In the distortion diagram, aberration at the d line is indicated by the solid line. In lateral chromatic aberration, aberrations at the C line, the F line, and the g line are respectively indicated by the long dashed line, the short dashed line, and the chain line. In spherical aberration diagram, FNo. indicates an F number. In the other aberration diagrams, ω indicates a half angle of view.

Symbols, meanings, description methods, and illustration methods of the respective data pieces according to Example 1 are the same as those in the following examples unless otherwise specified. Therefore, in the following description, repeated description will not be given.

### EXAMPLE 2

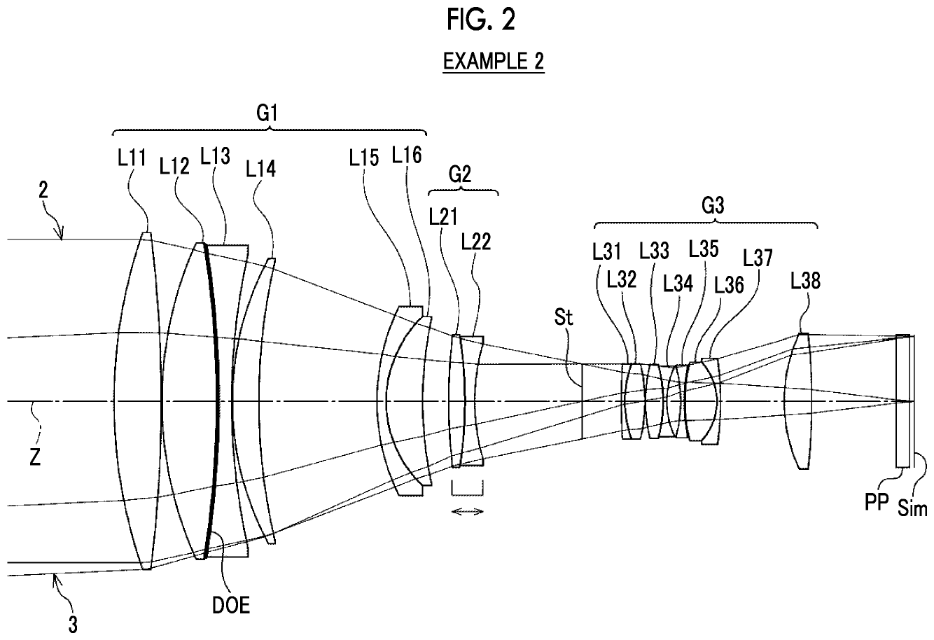

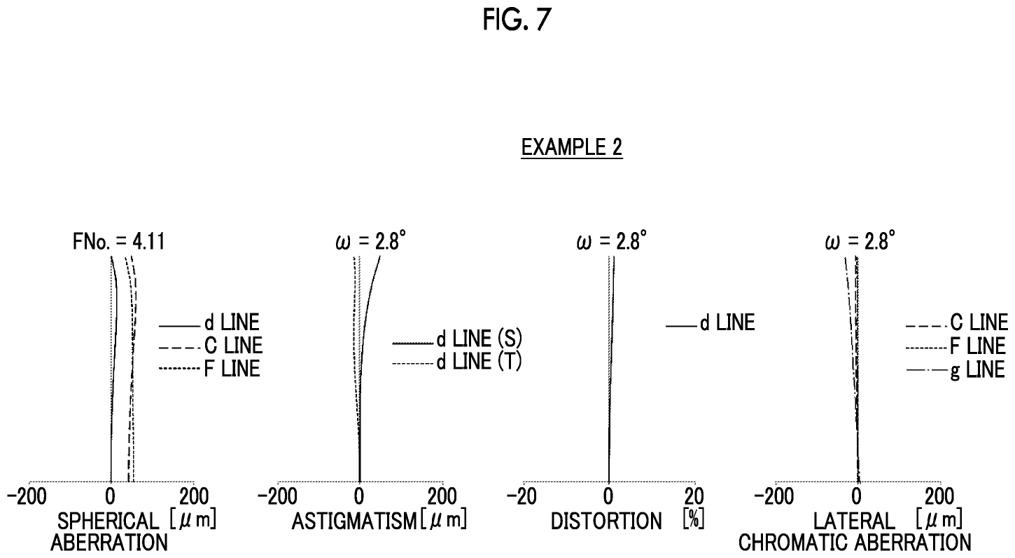

FIG. 2 is a cross-sectional view showing a configuration and luminous flux of the imaging lens of Example 2. The imaging lens of Example 2 has the same configuration as the outline of the imaging lens of Example 1 except that the diffractive optical surface DOE is disposed on the joint surface between the lens L12 and the lens L13. Regarding the imaging lens of Example 2, Table 4 shows basic lens data, Table 5 shows specification, and Table 6 shows phase difference coefficients thereof, and FIG. 7 shows aberration diagrams.

TABLE 4

| Sn | R | D | Nd | vd |
|---|---|---|---|---|
| 1 | 113.08196 | 10.225 | 1.48749 | 70.44 |
| 2 | −302.23036 | 0.150 | | |
| 3 | 85.35537 | 12.000 | 1.41390 | 100.82 |
| 4 | −222.50379 | 0.004 | 1.53458 | 18.90 |
| 5(DOE) | −222.50379 | 0.090 | 1.59952 | 45.78 |
| 6 | −222.50379 | 3.000 | 1.61772 | 49.81 |
| 7 | 148.80934 | 0.150 | | |
| 8 | 66.66938 | 5.725 | 1.56883 | 56.36 |
| 9 | 136.09268 | 25.559 | | |
| 10 | 47.63823 | 2.000 | 1.88300 | 40.76 |
| 11 | 25.80096 | 7.894 | 1.51633 | 64.14 |
| 12 | 86.02044 | 5.633 | | |
| 13 | 127.47123 | 3.497 | 1.60342 | 38.03 |
| 14 | −96.12246 | 2.000 | 1.72916 | 54.09 |
| 15 | 46.40659 | 23.253 | | |
| 16(St) | ∞ | 8.446 | | |
| 17 | 124.17045 | 0.800 | 1.92286 | 18.90 |
| 18 | 24.32319 | 4.297 | 1.60342 | 38.03 |
| 19 | −36.01186 | 0.150 | | |
| 20 | 34.11049 | 3.803 | 1.67270 | 32.10 |
| 21 | −32.36916 | 0.800 | 1.80400 | 46.53 |
| 22 | 18.16338 | 3.006 | | |
| 23 | −29.37447 | 0.800 | 1.72916 | 54.68 |
| 24 | 41.12802 | 0.150 | | |
| 25 | 37.07991 | 6.890 | 1.67270 | 32.10 |
| 26 | −12.94763 | 0.800 | 1.77250 | 49.60 |
| 27 | −66.62326 | 13.769 | | |
| 28 | 35.67986 | 5.964 | 1.51742 | 52.43 |
| 29 | −144.34030 | 18.286 | | |
| 30 | ∞ | 2.850 | 1.51680 | 64.20 |
| 31 | ∞ | 1.029 | | |

TABLE 5

| | |
|---|---|
| f | 292.91 |
| FNo. | 4.11 |
| 2ω(°) | 5.6 |

TABLE 6

| Sn | 5 |
|---|---|
| A2 | −4.73914E−01 |
| A4 | 1.94836E−05 |

### EXAMPLE 3

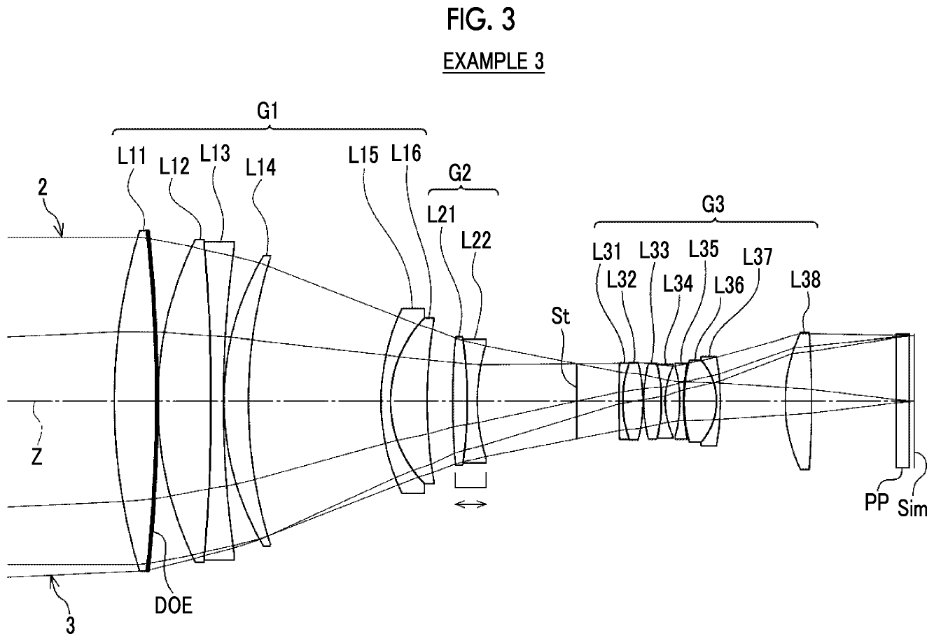

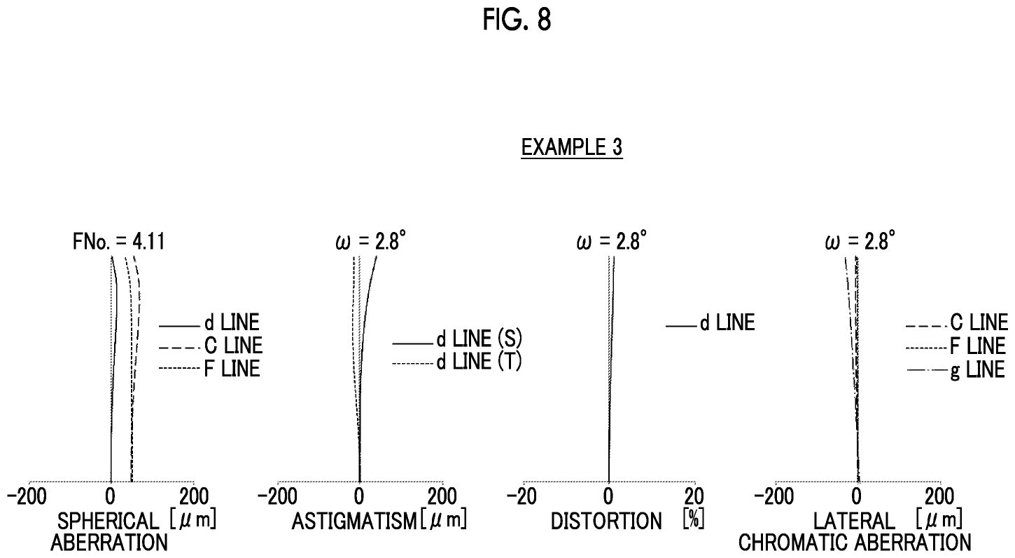

FIG. 3 is a cross-sectional view showing a configuration and luminous flux of the imaging lens of Example 3. The imaging lens of Example 3 has the same configuration as the outline of the imaging lens of Example 1 except that the diffractive optical surface DOE is disposed on the image side surface of the lens L11. Regarding the imaging lens of Example 3, Table 7 shows basic lens data, Table 8 shows specification, and Table 9 shows phase difference coefficients thereof, and FIG. 8 shows aberration diagrams.

TABLE 7

| Sn | R | D | Nd | vd |
|---|---|---|---|---|
| 1 | 129.24432 | 9.052 | 1.48749 | 70.44 |
| 2 | −347.79183 | 0.004 | 1.53458 | 18.90 |
| 3(DOE) | −347.79183 | 0.090 | 1.59952 | 45.78 |
| 4 | −347.79183 | 0.150 | | |
| 5 | 80.61519 | 11.414 | 1.41390 | 100.82 |
| 6 | −391.64494 | 2.610 | 1.63930 | 44.87 |
| 7 | 239.22570 | 0.150 | | |
| 8 | 63.15815 | 5.220 | 1.51633 | 64.14 |
| 9 | 106.59101 | 28.394 | | |
| 10 | 47.61319 | 2.000 | 1.88300 | 40.76 |
| 11 | 25.81210 | 7.835 | 1.48749 | 70.24 |
| 12 | 106.59407 | 5.496 | | |
| 13 | 160.86141 | 3.123 | 1.62004 | 36.26 |
| 14 | −96.52685 | 2.000 | 1.72916 | 54.68 |
| 15 | 42.18208 | 21.237 | | |
| 16(St) | ∞ | 9.091 | | |
| 17 | 303.65646 | 0.800 | 1.92286 | 20.88 |
| 18 | 25.62853 | 4.317 | 1.62004 | 36.26 |
| 19 | −34.94092 | 0.150 | | |
| 20 | 33.89456 | 3.816 | 1.62588 | 35.70 |
| 21 | −34.66003 | 0.800 | 1.72916 | 54.68 |
| 22 | 18.37082 | 3.113 | | |
| 23 | −30.27035 | 0.800 | 1.72916 | 54.68 |
| 24 | 43.58350 | 0.150 | | |
| 25 | 36.16232 | 6.925 | 1.63980 | 34.47 |
| 26 | −13.64572 | 0.800 | 1.75500 | 52.32 |
| 27 | −60.00064 | 13.858 | | |
| 28 | 35.51865 | 5.712 | 1.51823 | 58.90 |
| 29 | −197.81054 | 18.032 | | |
| 30 | ∞ | 2.850 | 1.51680 | 64.20 |
| 31 | ∞ | 1.034 | | |

TABLE 8

| | |
|---|---|
| f | 292.92 |
| FNo. | 4.11 |
| 2ω(°) | 5.6 |

TABLE 9

| Sn | 3 |
|---|---|
| A2 | −4.00320E−01 |
| A4 | 3.22018E−06 |

### EXAMPLE 4

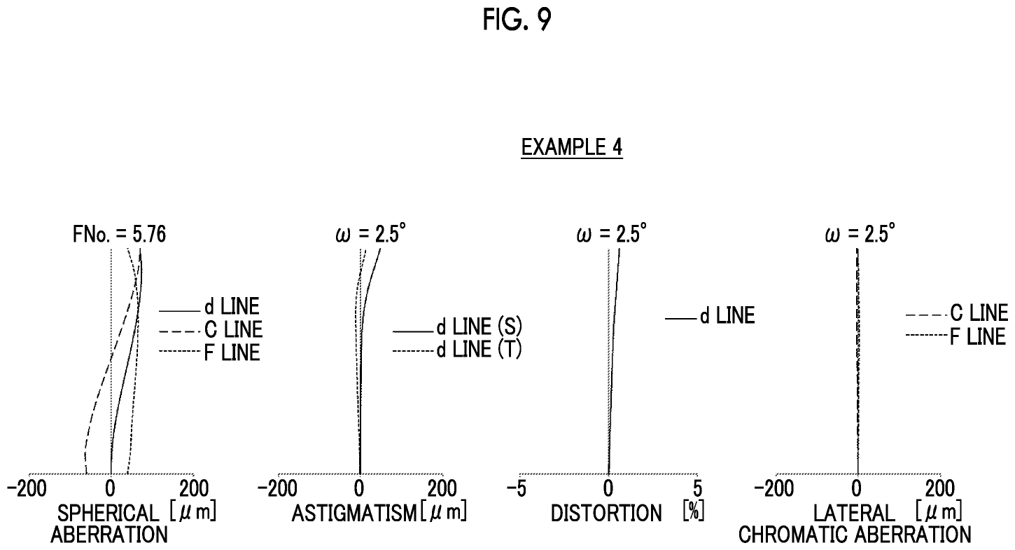

FIG. 4 is a cross-sectional view showing a configuration and luminous flux of the imaging lens of Example 4. The imaging lens of Example 4 has the same configuration as the outline of the imaging lens of Example 1 except for the configuration of the third lens group G3. The third lens group G3 of the imaging lens of Example 4 consists of, in order from the object side to the image side, a lens L31 which is a positive lens, a lens L32 which is a negative lens, lenses L33 and L34 which constitute a cemented lens, a lens L35 which is a negative lens, lenses L36 and L37 which constitute a cemented lens, lenses L38 and L39 which constitute a cemented lens, and lenses L40 and L41 which constitute a cemented lens. Regarding the imaging lens of Example 4, Table 10 shows basic lens data, Table 11 shows specification, and Table 12 shows phase difference coefficients thereof, and FIG. 9 shows aberration diagrams.

TABLE 10

| Sn | R | D | Nd | vd |
|---|---|---|---|---|
| 1 | 270.0994 | 11.9084 | 1.48749 | 70.44 |
| 2 | −312.9511 | 0.3043 | | |
| 3 | 140.0568 | 14.8112 | 1.48749 | 70.44 |
| 4 | −320.3107 | 3.7340 | 1.83481 | 42.74 |
| 5 | 547.8318 | 0.2282 | | |
| 6 | 68.3401 | 14.8050 | 1.48749 | 70.44 |
| 7 | 147.8345 | 0.0061 | 1.53458 | 18.91 |
| 8(DOE) | 147.8345 | 0.1371 | 1.59952 | 45.78 |
| 9 | 147.8345 | 25.4666 | | |
| 10 | 84.9012 | 3.8086 | 1.85150 | 40.78 |
| 11 | 35.2156 | 14.1029 | 1.51680 | 64.20 |
| 12 | 243.9917 | 6.7433 | | |
| 13 | 139.2829 | 5.8434 | 1.62004 | 36.26 |
| 14 | −147.1739 | 2.9704 | 1.75500 | 52.32 |
| 15 | 56.4154 | 19.7544 | | |
| 16(St) | ∞ | 6.0935 | | |
| 17 | 145.2541 | 3.2222 | 1.51823 | 58.90 |
| 18 | −91.0196 | 0.3043 | | |
| 19 | −1642.0733 | 2.2848 | 1.88300 | 40.76 |
| 20 | 62.1992 | 16.5517 | | |
| 21 | 181.3607 | 4.3896 | 1.84666 | 23.78 |
| 22 | −38.2184 | 1.9807 | 1.85150 | 40.78 |
| 23 | 59.4368 | 0.7405 | | |
| 24 | 209.8311 | 1.8283 | 1.91082 | 35.25 |
| 25 | 62.3102 | 4.8747 | | |
| 26 | 56.1503 | 2.2851 | 1.41390 | 100.82 |
| 27 | 26.0252 | 11.1839 | 1.59270 | 35.31 |
| 28 | −31.1784 | 0.6736 | | |
| 29 | −31.4564 | 2.1332 | 1.91082 | 35.25 |
| 30 | 31.9369 | 6.5886 | 1.84666 | 23.78 |
| 31 | −373.8406 | 3.8191 | | |
| 32 | 79.8397 | 10.3587 | 1.78880 | 28.43 |
| 33 | −29.0413 | 2.3613 | 1.95906 | 17.47 |
| 34 | −359.7555 | 49.0443 | | |
| 35 | ∞ | 4.3000 | 1.51680 | 64.20 |
| 36 | ∞ | 1.5600 | | |

TABLE 11

| | |
|---|---|
| f | 486.66 |
| FNo. | 5.76 |
| 2ω(°) | 5.0 |

TABLE 12

| Sn | 8 |
|---|---|
| A2 | −5.06607E−01 |
| A4 | 2.52075E−05 |
| A6 | −4.87876E−09 |
| A8 | 1.39728E−12 |
| A10 | −2.08135E−16 |

### EXAMPLE 5

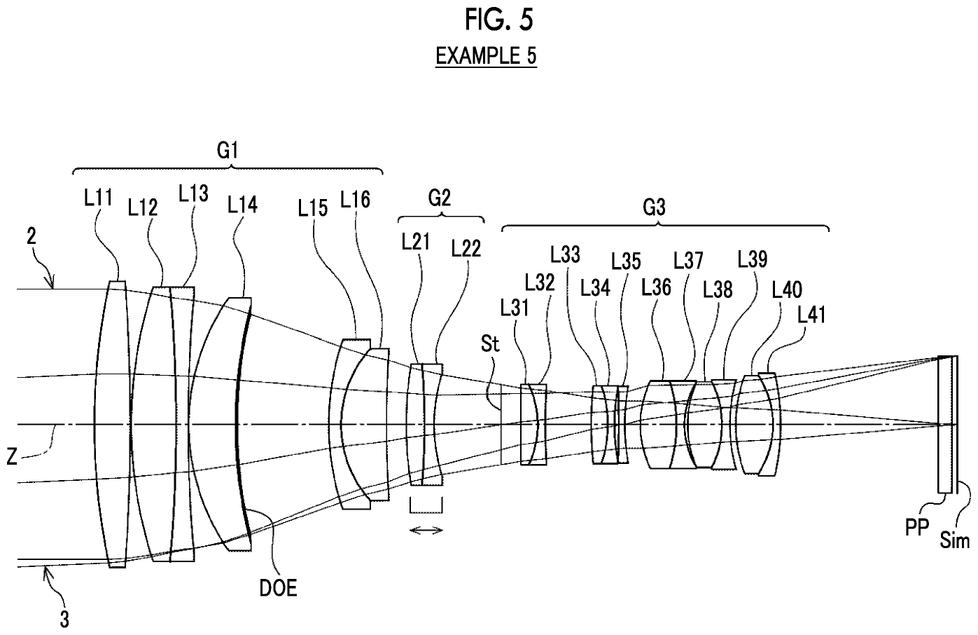

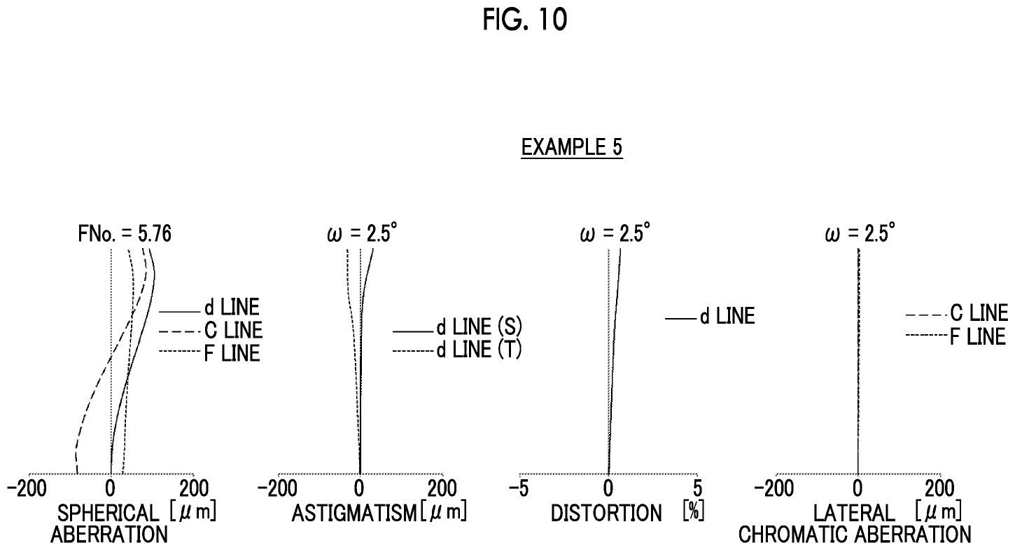

FIG. 5 is a cross-sectional view showing a configuration and luminous flux of the imaging lens of Example 5. The imaging lens of Example 5 has the same configuration as the outline of the imaging lens of Example 1 except for the configuration of the third lens group G3. The third lens group G3 of the imaging lens of Example 5 consists of, in order from the object side to the image side, lenses L31 and L32 which constitute a cemented lens, lenses L33 and L34 which constitute a cemented lens, a lens L35 which is a negative lens, lenses L36 and L37 which constitute a cemented lens, lenses L38 and L39 which constitute a cemented lens, and lenses L40 and L41 which constitute a cemented lens. Regarding the imaging lens of Example 5, Table 13 shows basic lens data, Table 14 shows specification, and Table 15 shows phase difference coefficients thereof, and FIG. 10 shows aberration diagrams.

TABLE 13

| Sn | R | D | Nd | vd |
|---|---|---|---|---|
| 1 | 212.2300 | 11.1657 | 1.48749 | 70.44 |
| 2 | −614.3512 | 0.3043 | | |
| 3 | 138.6497 | 13.9179 | 1.48749 | 70.44 |
| 4 | −490.9323 | 3.7197 | 1.83481 | 42.74 |
| 5 | 436.1064 | 0.2282 | | |
| 6 | 69.4253 | 14.6741 | 1.48749 | 70.44 |
| 7 | 148.1129 | 0.0061 | 1.53458 | 18.91 |
| 8(DOE) | 148.1129 | 0.1371 | 1.59952 | 45.78 |
| 9 | 148.1129 | 28.6454 | | |
| 10 | 83.9857 | 3.8083 | 1.91082 | 35.25 |
| 11 | 35.8281 | 14.0956 | 1.51742 | 52.43 |
| 12 | 340.5796 | 6.1155 | | |
| 13 | 114.5566 | 5.6989 | 1.71736 | 29.52 |
| 14 | −227.9731 | 2.9704 | 1.83481 | 42.74 |
| 15 | 52.8144 | 20.5920 | | |
| 16(St) | ∞ | 6.0936 | | |
| 17 | 1020.4402 | 5.2928 | 1.69350 | 50.81 |
| 18 | −29.4482 | 2.3716 | 1.67003 | 47.23 |
| 19 | 211.4650 | 14.2303 | | |
| 20 | 128.1996 | 5.1852 | 1.85478 | 24.80 |
| 21 | −37.1349 | 1.9956 | 1.85150 | 40.78 |
| 22 | 62.3785 | 1.3607 | | |
| 23 | −585.8112 | 1.8278 | 1.88300 | 40.76 |
| 24 | 65.0301 | 4.8753 | | |
| 25 | 31.6522 | 11.1970 | 1.51742 | 52.43 |
| 26 | −46.3436 | 2.4881 | 1.41390 | 100.82 |
| 27 | 25.6169 | 0.9853 | | |
| 28 | 33.5481 | 10.6789 | 1.60342 | 38.03 |
| 29 | −29.9605 | 2.4376 | 1.83481 | 42.74 |
| 30 | 51.2890 | 1.8278 | | |
| 31 | 43.3158 | 11.5480 | 1.62004 | 36.26 |
| 32 | −28.5191 | 2.3613 | 2.00272 | 19.32 |
| 33 | −74.5612 | 48.9434 | | |
| 34 | ∞ | 4.3000 | 1.51680 | 64.20 |
| 35 | ∞ | 1.6164 | | |

TABLE 14

| | |
|---|---|
| f | 486.86 |
| FNo. | 5.76 |
| 2ω(°) | 5.0 |

TABLE 15

| Sn | 8 |
|---|---|
| A2 | −4.92873E−01 |
| A4 | 2.71800E−05 |
| A6 | −5.46290E−09 |
| A8 | 8.75080E−13 |
| A10 | −1.82037E−16 |

Table 16 shows the corresponding values of Conditional Expressions (1) to (9) of the imaging lenses of Examples 1 to 5. In Examples 1 to 5, the d line is set as the reference wavelength. Table 16 shows the values based on the d line.

TABLE 16

| Ex- | | | | | | |
|---|---|---|---|---|---|---|
| pression | | Example | Example | Example | Example | Example |
| number | | 1 | 2 | 3 | 4 | 5 |
| (1) | F1/f | 0.727 | 0.581 | 0.655 | 0.261 | 0.275 |
| (2) | Bf/f | 0.076 | 0.072 | 0.072 | 0.110 | 0.109 |
| (3) | fC1/f | 1.338 | 31.668 | 1.673 | 2.116 | 2.072 |
| (4) | fs/f | 1.081 | 0.762 | 0.985 | 0.494 | 0.508 |
| (5) | fC2/f | −5.498 | −3.004 | −3.907 | −1.533 | −1.485 |
| (6) | fC3/f | 0.324 | 0.302 | 0.364 | −0.394 | −1.223 |
| (7) | fC4/f | −0.057 | −0.049 | −0.053 | −0.215 | −0.096 |
| (8) | fC5/f | 0.187 | 0.157 | 0.159 | 0.300 | 0.144 |
| (9) | fe/f | 0.196 | 0.191 | 0.200 | 0.300 | 0.144 |

As can be seen from the above data, the imaging lenses of Examples 1 to 5 have a short back focal length with respect to the focal length and are configured to have a small size. In addition, various aberrations are satisfactorily corrected, and high optical performance is achieved.

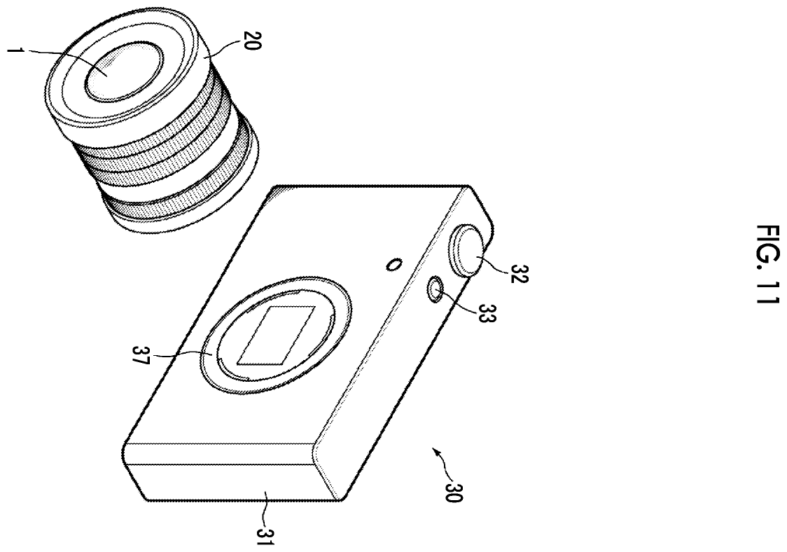

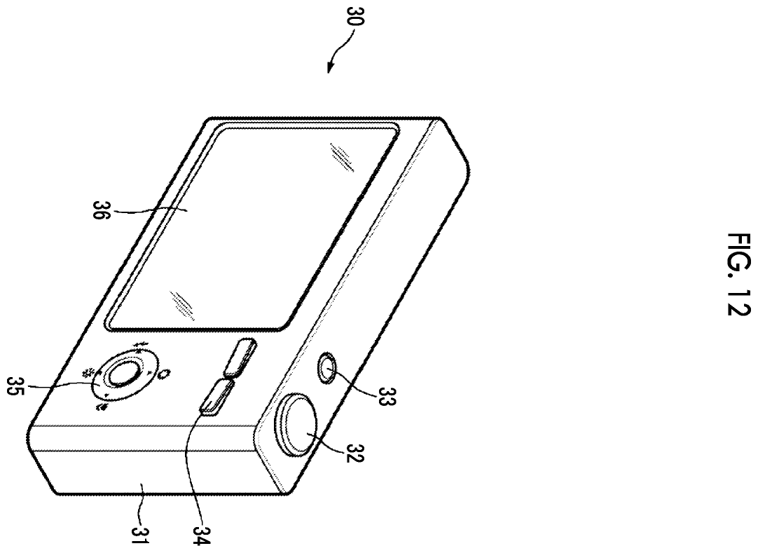

Next, an imaging apparatus according to an embodiment of the present disclosure will be described. FIGS. 11 and 12 are external views of a camera 30 which is the imaging apparatus according to the embodiment of the present disclosure. FIG. 11 is a perspective view of the camera 30 viewed from the front side, and FIG. 12 is a perspective view of the camera 30 viewed from the rear side. The camera 30 is a so-called mirrorless type digital camera, and the interchangeable lens 20 can be detachably attached thereto. The interchangeable lens 20 is configured to include the imaging lens 1, which is housed in a lens barrel, according to an embodiment of the present disclosure.

The camera 30 comprises a camera body 31, and a shutter button 32 and a power button 33 are provided on an upper surface of the camera body 31. Further, an operating part 34, an operating part 35, and a display unit 36 are provided on a rear surface of the camera body 31. The display unit 36 is able to display a captured image and an image within an angle of view before imaging

An imaging aperture stop, through which light from an imaging target is incident, is provided at the center on the front surface of the camera body 31. A mount 37 is provided at a position corresponding to the imaging aperture stop. The interchangeable lens 20 is mounted on the camera body 31 with the mount 37 interposed therebetween.

In the camera body 31, there are provided an imaging element, a signal processing circuit, a storage medium, and the like. The imaging element such as a charge coupled device (CCD) or a complementary metal oxide semiconductor (CMOS) outputs a captured image signal based on a subject image which is formed through the interchangeable lens 20. The signal processing circuit generates an image through processing of the captured image signal which is output from the imaging element. The storage medium stores the generated image. The camera 30 is able to capture a still image or a video by pressing the shutter button 32, and is able to store image data, which is obtained through imaging, in the storage medium.

The technology of the present disclosure has been hitherto described through embodiments and examples, but the technology of the present disclosure is not limited to the above-mentioned embodiments and examples, and may be modified into various forms. For example, values such as the curvature radius, the surface distance, the refractive index, the Abbe number, and the phase difference coefficient of each lens are not limited to the values shown in the examples, and different values may be used therefor.

In the above-mentioned example, the subsequent lens group GR consists of one lens group, but the subsequent lens group GR may be configured to consist of two or more lens groups whose mutual distance in the direction of the optical axis changes during focusing. The term “lens group” as used herein refers to a group of lenses that are moved or remain stationary in units of lens groups during focusing, and the distance between lenses in the group does not change. Further, the subsequent lens group GR may be configured to include a lens group that moves during focusing.

In Example 4, one cemented lens adjacent to the aperture stop St on the object side of the aperture stop St is used as the focus group. However, as a modification example of Example 4, it is possible to adopt a configuration in which one cemented lens adjacent to the aperture stop St on the image side of the aperture stop St is used as the focus group. That is, in this modification example, the first lens group G1 consists of all the lenses (lenses L11 to L16 and lenses L21 and L22 in FIG. 4) on the object side of the aperture stop St, the second lens group G2 consists of one cemented lens (lenses L31 and L32 in FIG. 4) adjacent to the aperture stop St on the image side of the aperture stop St, and the subsequent lens group GR consists of all the lenses (lenses L33 to L41 in FIG. 4) closer to the image side than the second lens group G2. A similar modification example can be considered for Example 5.

Further, the imaging apparatus according to the embodiment of the present disclosure is not limited to the above example, and may be modified into various forms such as a camera other than the mirrorless type, a film camera, and a video camera.

The entire disclosures of JP2019-119981A filed on Jun. 27, 2019 and JP2019-237435A filed on Dec. 26, 2019 are incorporated into the present specification by reference. All documents, patent applications, and technical standards described in the present specification are incorporated into the present specification by reference to the same extent as in a case where the individual documents, patent applications, and technical standards were specifically and individually stated to be incorporated by reference.

What is claimed is:

1. An imaging lens comprising, as lens groups, only three lens groups consisting of, in order from an object side to an image side:
a first lens group that remains stationary with respect to an image plane during focusing;
a second lens group that moves along an optical axis during focusing; and
a third lens group that remains stationary with respect to the image plane during focusing,
wherein the first lens group has at least two cemented lenses in which at least one positive lens and at least one negative lens are cemented, and
assuming that
a focal length of a lens closest to the object side in the first lens group is f1,
a focal length of the imaging lens in a state where an infinite distance object is in focus is f, and
an air conversion distance on the optical axis from a lens surface closest to the image side to a focal position on the image side of the imaging lens in a state where an infinite distance object is in focus is Bf,
Conditional Expressions (1) and (2) are satisfied, which are represented by
0.1<f1/f<1 (1), and
Bf/f<0.14 (2).

2. An imaging lens comprising, as lens groups, successively in order from a position closest to an object side to an image side:
a first lens group that remains stationary with respect to an image plane during focusing;
a second lens group that moves along an optical axis during focusing; and
a subsequent lens group that is at a distance which is changeable in a direction of the optical axis from the second lens group during focusing,
wherein the first lens group has at least two cemented lenses in which at least one positive lens and at least one negative lens are cemented, and
the subsequent lens group has at least two cemented lenses in which at least one positive lens and at least one negative lens are cemented, and
assuming that
a focal length of a lens closest to the object side in the first lens group is f1,
a focal length of the imaging lens in a state where an infinite distance object is in focus is f, and
an air conversion distance on the optical axis from a lens surface closest to the image side to a focal position on the image side of the imaging lens in a state where an infinite distance object is in focus is Bf,
Conditional Expressions (1) and (2) are satisfied, which are represented by
0.1<f1/f<1 (1), and
Bf/f<0.14 (2).

3. The imaging lens according to claim 2, wherein the subsequent lens group consists of a third lens group that remains stationary with respect to the image plane during focusing.

4. The imaging lens according to claim 1, wherein assuming that a focal length of the cemented lens closest to the object side in the first lens group is fC1, Conditional Expression (3) is satisfied, which is represented by
0<fC1/f<150 (3).

5. The imaging lens according to claim 1, wherein assuming that a focal length of a single lens or the cemented lens adjacent to the image side of the cemented lens closest to the object side in the first lens group is fs, Conditional Expression (4) is satisfied, which is represented by
0<fs/f<2.5 (4).

6. The imaging lens according to claim 1, wherein assuming that a focal length of the cemented lens of the first lens group, which is different from the cemented lens closest to the object side in the first lens group, is fC2, at least one cemented lens is provided, which satisfies Conditional Expression (5) represented by
−30<fC2/f<30 (5).

7. The imaging lens according to claim 1,
wherein the third lens group has at least one cemented lens, and
assuming that a focal length of a cemented lens closest to the object side in the third lens group is fC3, Conditional Expression (6) is satisfied, which is represented by
−8<fC3/f<8 (6).

8. The imaging lens according to claim 1,
wherein a stop is disposed between a lens surface closest to the image side in the first lens group and a lens surface closest to the object side in the third lens group,
the third lens group has at least one cemented lens, and
assuming that a combined focal length of three lenses disposed successively adjacent to the image side of a cemented lens closest to the object side in the third lens group is fC4,
Conditional Expression (7) is satisfied, which is represented by
−1<fC4/f<0 (7).

9. The imaging lens according to claim 1, wherein at least one cemented lens closer to the image side than the second lens group is provided, and
assuming that a focal length of a cemented lens closest to the image side is fC5, Conditional Expression (8) is satisfied, which is represented by
0.05<fC5/f<1 (8).

10. The imaging lens according to claim 1, wherein assuming that a focal length of a single lens or a cemented lens closest to the image side is fe, Conditional Expression (9) is satisfied, which is represented by
0<fe/f<0.4 (9).

11. The imaging lens according to claim 1, wherein a diffractive optical surface is provided.

12. The imaging lens according to claim 11, wherein the diffractive optical surface is disposed in the first lens group.

13. The imaging lens according to claim 1, wherein a lens having an Abbe number greater than 100 based on a d line is provided.

14. The imaging lens according to claim 13, wherein the lens having an Abbe number greater than 100 based on the d line is a positive lens.

15. The imaging lens according to claim 13, wherein the first lens group includes the lens having an Abbe number greater than 100 based on the d line.

16. The imaging lens according to claim 15, wherein the cemented lens closest to the object side in the first lens group includes the lens having an Abbe number greater than 100 based on the d line.

17. The imaging lens according to claim 1, wherein a cemented lens in which a positive lens and a negative lens are cemented is disposed closest to the image side.

18. The imaging lens according to claim 1, wherein at least four cemented lenses closer to the image side than the second lens group are provided.

19. The imaging lens according to claim 1, wherein Conditional Expression (1-1) is satisfied, which is represented by
0.2<f1/f<0.8 (1-1).

20. An imaging apparatus comprising the imaging lens according to claim 1.

21. The imaging lens according to claim 2, wherein assuming that a focal length of the cemented lens closest to the object side in the first lens group is fC1, Conditional Expression (3) is satisfied, which is represented by
0<fC1/f<150 (3).

22. The imaging lens according to claim 2, wherein assuming that a focal length of a single lens or the cemented lens adjacent to the image side of the cemented lens closest to the object side in the first lens group is fs, Conditional Expression (4) is satisfied, which is represented by
0<fs/f<2.5 (4).

23. The imaging lens according to claim 2, wherein assuming that a focal length of the cemented lens of the first lens group, which is different from the cemented lens closest to the object side in the first lens group, is fC2, at least one cemented lens is provided, which satisfies Conditional Expression (5) represented by
−30<fC2/f<30 (5).

24. The imaging lens according to claim 2,
wherein the third lens group has at least one cemented lens, and
assuming that a focal length of a cemented lens closest to the object side in the third lens group is fC3, Conditional Expression (6) is satisfied, which is represented by
−8<fC3/f<8 (6).

25. The imaging lens according to claim 2,
wherein a stop is disposed between a lens surface closest to the image side in the first lens group and a lens surface closest to the object side in the third lens group,
the third lens group has at least one cemented lens, and
assuming that a combined focal length of three lenses disposed successively adjacent to the image side of a cemented lens closest to the object side in the third lens group is fC4,
Conditional Expression (7) is satisfied, which is represented by
−1<fC4/f<0 (7).

26. The imaging lens according to claim 2, wherein at least one cemented lens closer to the image side than the second lens group is provided, and
assuming that a focal length of a cemented lens closest to the image side is fC5, Conditional Expression (8) is satisfied, which is represented by
0.05<fC5/f<1 (8).

27. The imaging lens according to claim 2, wherein assuming that a focal length of a single lens or a cemented lens closest to the image side is fe, Conditional Expression (9) is satisfied, which is represented by
0<fe/f<0.4 (9).

28. The imaging lens according to claim 2, wherein a diffractive optical surface is provided.

29. The imaging lens according to claim 28, wherein the diffractive optical surface is disposed in the first lens group.

30. The imaging lens according to claim 2, wherein a lens having an Abbe number greater than 100 based on a d line is provided.

31. The imaging lens according to claim 30, wherein the lens having an Abbe number greater than 100 based on the d line is a positive lens.

32. The imaging lens according to claim 30, wherein the first lens group includes the lens having an Abbe number greater than 100 based on the d line.

33. The imaging lens according to claim 32, wherein the cemented lens closest to the object side in the first lens group includes the lens having an Abbe number greater than 100 based on the d line.

34. The imaging lens according to claim 2, wherein a cemented lens in which a positive lens and a negative lens are cemented is disposed closest to the image side.

35. The imaging lens according to claim 2, wherein at least four cemented lenses closer to the image side than the second lens group are provided.

36. The imaging lens according to claim 2, wherein Conditional Expression (1-1) is satisfied, which is represented by
0.2<f1/f<0.8 (1-1).

37. An imaging apparatus comprising the imaging lens according to claim 2.
